(19) United States
(12) Patent Application Publication
(10) Pub. No.: US 2025/0200788 A1
(43) Pub. Date: Jun. 19, 2025

(54) VEHICLE POSE DETERMINATION

(71) Applicant: Ford Global Technologies, LLC, Dearborn, MI (US)

(72) Inventors: Subodh Mishra, Bryan, TX (US); Sharnam Shah, San Francisco, CA (US); Ankit Girish Vora, Northville, MI (US); Nalin Bendapudi, Ann Arbor, MI (US); Kevin Chen, Jersey City, NJ (US); Gaurav Pandey, College Station, TX (US); Md Nahid Pervez, San Jose, CA (US); Jacob Skwirsk, Ann Arbor, MI (US); Alexander Carr, Detroit, MI (US)

(73) Assignee: Ford Global Technologies, LLC, Dearborn, MI (US)

(21) Appl. No.: 18/543,148

(22) Filed: Dec. 18, 2023

(51) Int. Cl. G06T 7/73; B60W 60/00; G01C 21/30; G01S 19/42; G06V 20/58

(52) U.S. Cl. CPC G06T 7/73; B60W 60/001; G01C 21/30; G01S 19/42; G06V 20/58; G06T 2207/20041

(57) ABSTRACT

A computer includes a processor and a memory, and the memory stores instructions executable by the processor to detect static environmental features in a camera image from a camera of a vehicle, generate a distance transform image of the static environmental features as detected in the camera image, and determine a pose of the vehicle based on a comparison of map data indicating the static environmental features with the distance transform image. Pixel values of respective pixels in the distance transform image indicate respective pixel distances of the respective pixels from the static environmental features in the distance transform image.

### BACKGROUND

Advanced driver assistance systems (ADAS) are electronic technologies that assist drivers in driving and parking functions. Examples of ADAS include forward proximity detection, lane-departure detection, blind-spot detection, braking actuation, adaptive cruise control, and lane-keeping assistance systems.

### BRIEF DESCRIPTION OF THE DRAWINGS

FIG. 1 is a block diagram of an example vehicle.

FIG. 2 is a block diagram of an example algorithm for determining a pose of the vehicle.

FIG. 3A is an example camera image with static environmental features detected.

FIG. 3B is an example binary image depicting the static environmental features detected in the camera image of FIG. 3A.

FIG. 3C is an example distance transform image generated based on the binary image of FIG. 3B.

FIG. 3D is a three-dimensional plot of pixel values of the distance transform image of FIG. 3C.

FIG. 3E is an example cross-section of the three-dimensional plot of FIG. 3D.

FIG. 4A is another example camera image with static environmental features detected.

FIG. 4B is an example binary image depicting the static environmental features detected in the camera image of FIG. 4A.

FIG. 4C is an example distance transform image generated based on the binary image of FIG. 4B.

FIG. 5A is another example camera image with static environmental features detected.

FIG. 5B is an example distance transform image generated based on the camera image of FIG. 5A.

FIG. 6 is a diagram of map data projected and transformed on the binary image of FIG. 3B.

FIG. 7 is a flowchart of an example process for determining the pose of the vehicle.

### DETAILED DESCRIPTION

This disclosure describes techniques for determining a pose of a vehicle based on static environmental features detected in a camera image and map data of the static environmental features. The pose of the vehicle includes the position and/or orientation of the vehicle, and some advanced driver assistance systems (ADAS) can use the pose as an input. The static environmental features may include lane lines, lampposts, etc. To determine the pose, a computer of the vehicle uses what will be referred to as a “distance transform image.” The distance transform image is a two-dimensional matrix of pixels, and each pixel may have a scalar pixel value indicating a pixel distance of that pixel from the nearest position of one of the static environmental features in the distance transform image. A pixel that coincides with the position of one of the static environmental features may have a pixel value of zero, and the pixel values may increase at positions farther from the coinciding pixel. The computer of the vehicle is programmed to detect the static environmental features in the camera image, generate the distance transform image of the static environmental features, and determine the pose of the vehicle based on a comparison of map data indicating the static environmental features with the distance transform image. For example, the computer may use the distance transform image to calculate a cost function optimizing a projection of the map data of the static environmental features to the image plane of the distance transform image. The projection can indicate the pose of the vehicle.

A computer includes a processor and a memory, and the memory stores instructions executable by the processor to detect static environmental features in a camera image from a camera of a vehicle, generate a distance transform image of the static environmental features as detected in the camera image, and determine a pose of the vehicle based on a comparison of map data indicating the static environmental features with the distance transform image. Pixel values of respective pixels in the distance transform image indicate respective pixel distances of the respective pixels from the static environmental features in the distance transform image.

In an example, the instructions may further include instructions to calculate a value of a cost function based on the map data indicating the static environmental features and the distance transform image, and determine the pose of the vehicle that minimizes the value of the cost function. In a further example, the instructions may further include instructions to project the map data indicating the static environmental features onto the distance transform image, and calculate the value of the cost function based on the pixel values of the pixels onto which the map data was projected.

In another further example, the pose may be a first pose, and the instructions may further include instructions to determine a global navigation satellite system (GNSS) pose based on GNSS data, and initialize the first pose at the GNSS pose for minimizing the value of the cost function.

In an example, the static environmental features may include lane lines.

In an example, the distance transform image may be an overhead distance transform image from an overhead perspective. In a further example, the pose may be a first pose, and the instructions may further include instructions to generate an image-plane distance transform image from a perspective of the camera, and determine a second pose based on the first pose and based on a comparison of the map data indicating the static environmental features with the image-plane distance transform image. In a yet further example, the instructions may further include instructions to calculate a value of a cost function based on the map data indicating the static environmental features and the image-plane distance transform image, and determine the second pose of the vehicle that minimizes the value of the cost function. In a still yet further example, the instructions may further include instructions to initialize the second pose at the first pose for minimizing the value of the cost function.

In another yet further example, the first pose may include only two horizontal spatial dimensions and a heading, and the second pose may include three spatial dimensions and three angular dimensions.

In an example, the distance transform image may be an image-plane distance transform image from a perspective of the camera. In a further example, the static environmental features may include linearly vertical features.

In an example, the instructions may further include instructions to generate a binary image depicting the static environmental features, and generate the distance transform image based on the binary image from a same perspective as the binary image. In a further example, the binary image may depict only the static environmental features.

In an example, the pose may include two horizontal spatial dimensions and a heading.

In an example, the instructions may further include instructions to actuate a component of the vehicle based on the pose of the vehicle.

A method includes detecting static environmental features in a camera image from a camera of a vehicle, generating a distance transform image of the static environmental features as detected in the camera image, and determining a pose of the vehicle based on a comparison of map data indicating the static environmental features with the distance transform image. Pixel values of respective pixels in the distance transform image indicate respective pixel distances of the respective pixels from the static environmental features in the distance transform image.

In an example, the method further includes calculating a value of a cost function based on the map data indicating the static environmental features and the distance transform image, and determining the pose of the vehicle that minimizes the value of the cost function. In a further example, the method further includes projecting the map data indicating the static environmental features onto the distance transform image, and calculating the value of the cost function based on the pixel values of the pixels onto which the map data was projected.

In an example, the method further includes generating a binary image depicting the static environmental features, and generating the distance transform image based on the binary image from a same perspective as the binary image.

With reference to the Figures, wherein like numerals indicate like parts throughout the several views, a computer 105 includes a processor and a memory, and the memory stores instructions executable by the processor to detect static environmental features 310 in a camera image 305 from a camera 110 of a vehicle 100, generate a distance transform image 315 of the static environmental features 310 as detected in the camera image 305, and determine a pose 205, 210 of the vehicle 100 based on a comparison of map data 245 indicating the static environmental features 310 with the distance transform image 315. Pixel values of respective pixels in the distance transform image 315 indicate respective pixel distances of the respective pixels from the static environmental features 310 in the distance transform image 315.

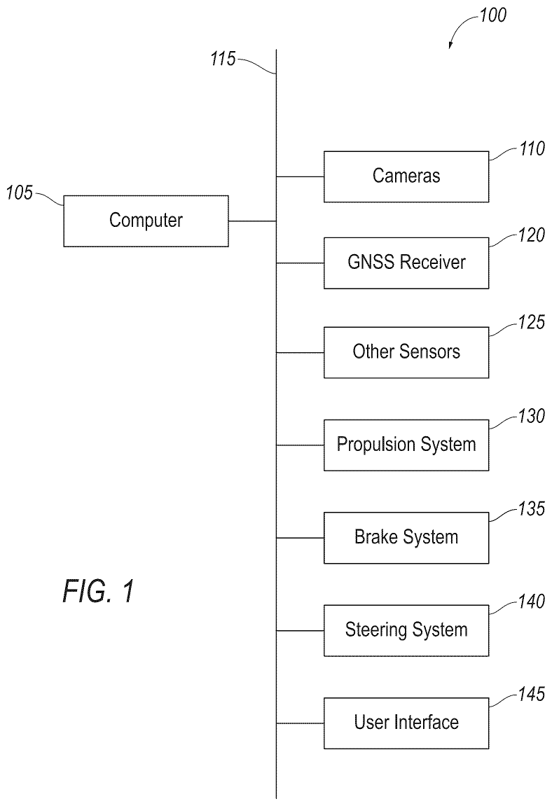

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 115, the camera(s) 110, a global navigation satellite system (GNSS) receiver 120, other sensors 125, a propulsion system 130, a brake system 135, a steering system 140, and a user interface 145.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be, e.g., a controller area network (CAN) bus, Ethernet, WiFi, Local Interconnect Network (LIN), onboard diagnostics connector (OBD-II), and/or any other wired or wireless communications network. The computer 105 may be communicatively coupled to the cameras 110, the GNSS receiver 120, the other sensors 125, the propulsion system 130, the brake system 135, the steering system 140, the user interface 145, and other components via the communications network 115.

The vehicle 100 includes at least one camera 110, e.g., a plurality of cameras 110. The cameras 110 can detect electromagnetic radiation in some range of wavelengths. For example, the cameras 110 may detect visible light, infrared radiation, ultraviolet light, or some range of wavelengths including visible, infrared, and/or ultraviolet light. For example, the cameras 110 can be a charge-coupled devices (CCD), complementary metal oxide semiconductors (CMOS), or any other suitable type. The cameras 110 may form a surround view camera system with the cameras 110 oriented in different directions away from the vehicle 100, e.g., at least one camera 110 facing forward, at least one camera 110 facing rightward, at least one camera 110 facing leftward, and at least one camera 110 facing rearward. The cameras 110 may support other features besides what is discussed herein, e.g., ADAS features such as parking assist.

The GNSS receiver 120 receives data from GNSS satellites. Systems for GNSS include the global positioning system (GPS), GLONASS, BeiDou, Galileo, etc. The GNSS satellites broadcast time and geolocation data. The GNSS receiver 120 or the computer 105 can determine a GNSS pose 215 of the vehicle 100, e.g., latitude and longitude, based on the GNSS receiver 120 receiving the time and geolocation data from multiple GNSS satellites simultaneously and using principles of trilateration.

The other sensors 125 may provide data about operation of the vehicle 100, for example, wheel speed, wheel orientation, and engine and transmission data (e.g., temperature, fuel consumption, etc.). The other sensors 125 may detect the location and/or orientation of the vehicle 100. For example, the other sensors 125 may include accelerometers such as piezo-electric or microelectromechanical systems (MEMS); gyroscopes such as rate, ring laser, or fiber-optic gyroscopes; inertial measurements units (IMU); and magnetometers. The other sensors 125 may detect the external world, e.g., objects and/or characteristics of surroundings of the vehicle 100, such as other vehicles, road lane markings, traffic lights and/or signs, road users, etc. For example, the other sensors 125 may include radar sensors, ultrasonic sensors, scanning laser range finders, and light detection and ranging (lidar) devices.

The propulsion system 130 of the vehicle 100 generates energy and translates the energy into motion of the vehicle 100. The propulsion system 130 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 130 can include an electronic control unit (ECU) or the like that is in communication with and receives input from the computer 105 and/or a human operator. The human operator may control the propulsion system 130 via, e.g., an accelerator pedal and/or a gear-shift lever.

The brake system 135 is typically a conventional vehicle braking subsystem and resists the motion of the vehicle 100 to thereby slow and/or stop the vehicle 100. The brake system 135 may include friction brakes such as disc brakes, drum brakes, band brakes, etc.; regenerative brakes; any other suitable type of brakes; or a combination. The brake system 135 can include an electronic control unit (ECU) or the like that is in communication with and receives input from the computer 105 and/or a human operator. The human operator may control the brake system 135 via, e.g., a brake pedal.

The steering system 140 is typically a conventional vehicle steering subsystem and controls the turning of the wheels. The steering system 140 may be a rack-and-pinion system with electric power-assisted steering, a steer-by-wire system, as both are known, or any other suitable system. The steering system 140 can include an electronic control unit (ECU) or the like that is in communication with and receives input from the computer 105 and/or a human operator. The human operator may control the steering system 140 via, e.g., a steering wheel.

The user interface 145 presents information to and receives information from an operator of the vehicle 100. The user interface 145 may be located, e.g., on an instrument panel in a passenger compartment of the vehicle 100, or wherever may be readily seen by the operator. The user interface 145 may include dials, digital readouts, screens, speakers, and so on for providing information to the operator, e.g., human-machine interface (HMI) elements such as are known. The user interface 145 may include buttons, knobs, keypads, microphone, and so on for receiving information from the operator.

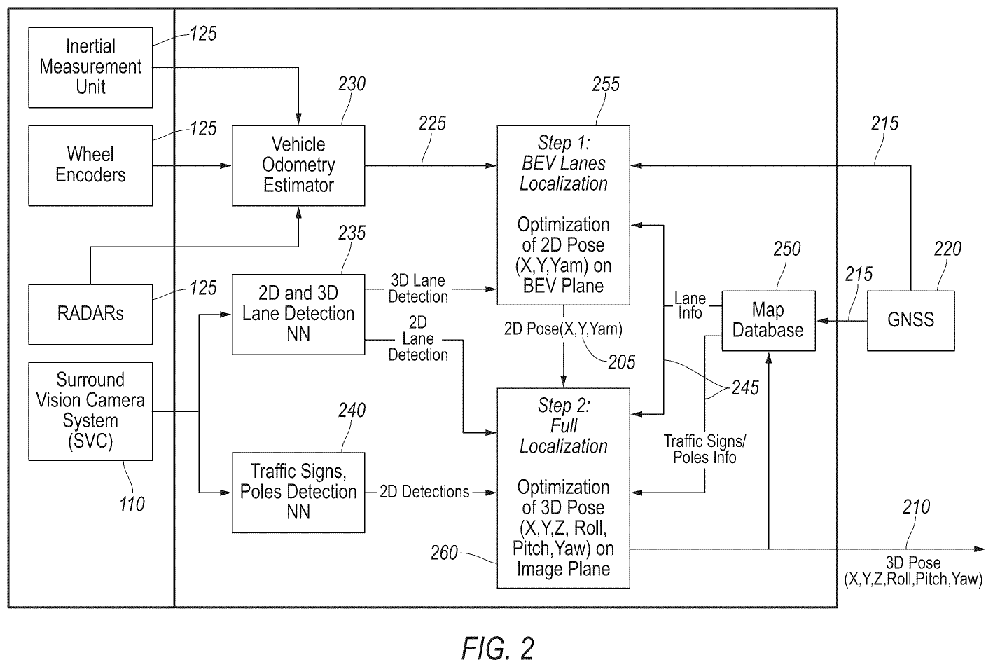

With reference to FIG. 2, the computer 105 is programmed to determine the pose 205, 210 of the vehicle 100. The pose 205, 210 describes the position and/or orientation of the vehicle 100. The pose 205, 210 may include at least two horizontal spatial dimensions and one angular dimension such as heading (also referred to as yaw). For example, the pose 205, 210 may include only two horizontal spatial dimensions and a heading or may include three spatial dimensions and three angular dimensions. In the specific example below, the computer 105 determines two poses 205, 210 at two stages of the process, which will be referred to as a first pose 205 and a second pose 210. The first pose 205 may include only two horizontal spatial dimensions and a heading, and the first pose 205 may be used as an input for determining the second pose 210. The second pose 210 may include three spatial dimensions and three angular dimensions.

The computer 105 determines the poses 205, 210 based on the static environmental features 310. The static environmental features 310 are aspects of the environment surrounding the vehicle 100 that remain unchanging over time. The static environmental features 310 may be chosen to both be described in the map data 245 and to be detectable in the camera image 305. For example, the static environmental features 310 may include generally horizontal edges such as lane lines and linearly vertical features such as lampposts, traffic-light poles, power-line poles, etc. The linearly vertical features are chosen to be the types of features that are elongated linearly along a vertical dimension, i.e., a feature that is straight up and down or that has a predominant subcomponent that is straight up and down. The computer 105 may use the lane lines when determining the first pose 205 because the first pose 205 is determined from an overhead perspective (as will be described). The computer 105 may use both the lane lines and the linearly vertical features when determining the second pose 210 because the second pose 210 is determined from a perspective of the camera 110 (as will also be described).

As a general overview, the computer 105 determines the GNSS pose 215 at a GNSS block 220, and the computer 105 determines an odometry pose 225 at an odometry block 230 based on data from the other sensors 125. The computer 105 detects some of the static environmental features 310, e.g., lane lines, in a camera image 305 from the camera 110 in a lane-detection block 235. The computer 105 detects others of the static environmental features 310, e.g., the linearly vertical features, in the camera image 305 in a vertical-detection block 240. The computer 105 extracts map data 245 indicating the static environmental features 310 in a map block 250. In a lane-localization block 255, the computer 105 determines the first pose 205 based on the GNSS pose 215, the odometry pose 225, the map data 245, and the detected static environmental features 310 from the lane-detection block 235. The computer 105 initializes the first pose 205 to either the GNSS pose 215 or the odometry pose 225 and, starting with the initialized first pose 205, determines the final first pose 205 based on a comparison of the map data 245 indicating the static environmental features 310 with an overhead distance transform image 315a generated from the static environmental features 310 detected in the camera image 305. In a full-localization block 260, the computer 105 determines the second pose 210 based on the first pose 205, the map data 245, and the detected static environmental features 310 from the lane-detection block 235 and the vertical-detection block 240. The computer 105 initializes the second pose 210 to the first pose 205 and, starting with the initialized second pose 210, determines the final second pose 210 based on a comparison of the map data 245 indicating the static environmental features 310 with an image-plane distance transform image 315b generated from the static environmental features 310 detected in the camera image 305.

In the GNSS block 220, the computer 105 or GNSS receiver 120 determines the GNSS pose 215 of the vehicle 100 from the GNSS data received by the GNSS receiver 120. The GNSS pose 215 describes the position and/or orientation of the vehicle 100, e.g., two horizontal spatial dimensions such as latitude and longitude and one angular dimensions such as heading, or three spatial dimensions and three angular dimensions. The computer 105 or GNSS receiver 120 uses trilateration to determine the GNSS pose 215, as is known. The GNSS pose 215 may be specified in an absolute coordinate system, i.e., a coordinate system that is fixed with respect to the earth. The GNSS pose 215 is provided to the lane-localization block 255.

In the map block 250, the computer 105 extracts the map data 245 indicating the static environmental features 310, e.g., from a map database stored in the memory of the computer 105. The map data 245 may be specified as positions in the absolute coordinate system paired with specific static environmental features.

In the odometry block 230, the computer 105 estimates an odometry pose 225 of the vehicle 100 based on data from the other sensors 125, e.g., proprioceptive measurements, i.e., self-sensing measurements of movement. For example, the odometry pose 225 may be based on data from wheel speed sensors and inertial measurement units (IMUs) of the other sensors 125. The odometry pose 225 may also be based on changes in radar measurements of stationary objects in the environment. The computer 105 may estimate the odometry pose 225 by integrating the velocity vectors inferred from the data from the other sensors 125 from a previous time to a current time, resulting in a change in position and orientation, and adding the change in position and orientation to a previous pose from the previous time, i.e., inertial navigation. The previous pose may be, e.g., a previously determined second pose 210, a previous GNSS pose 215 if a recent second pose 210 is not available, or a previous odometry pose 225 if a recent GNSS pose 215 is not available.

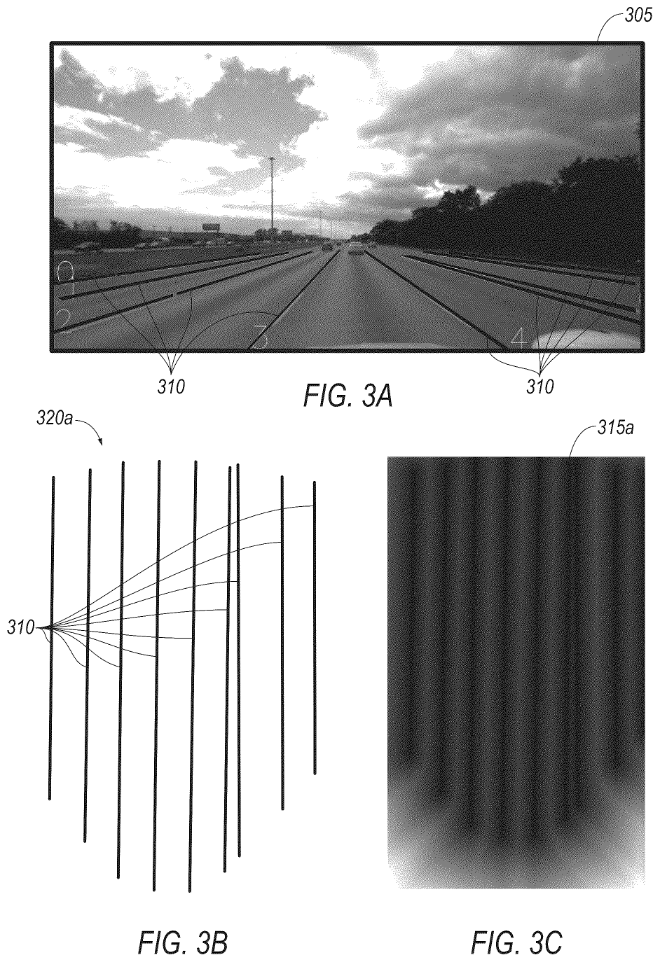

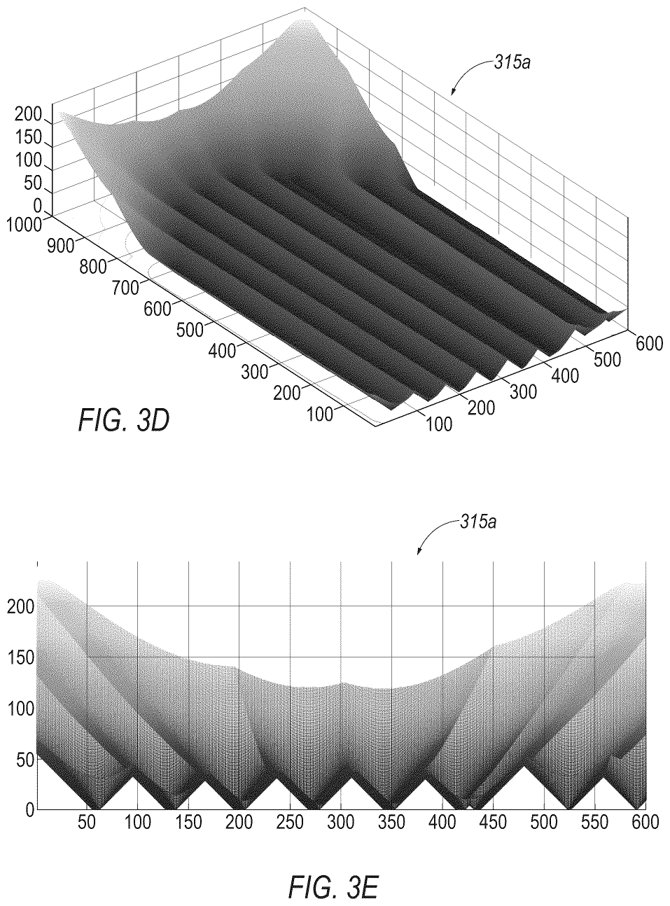

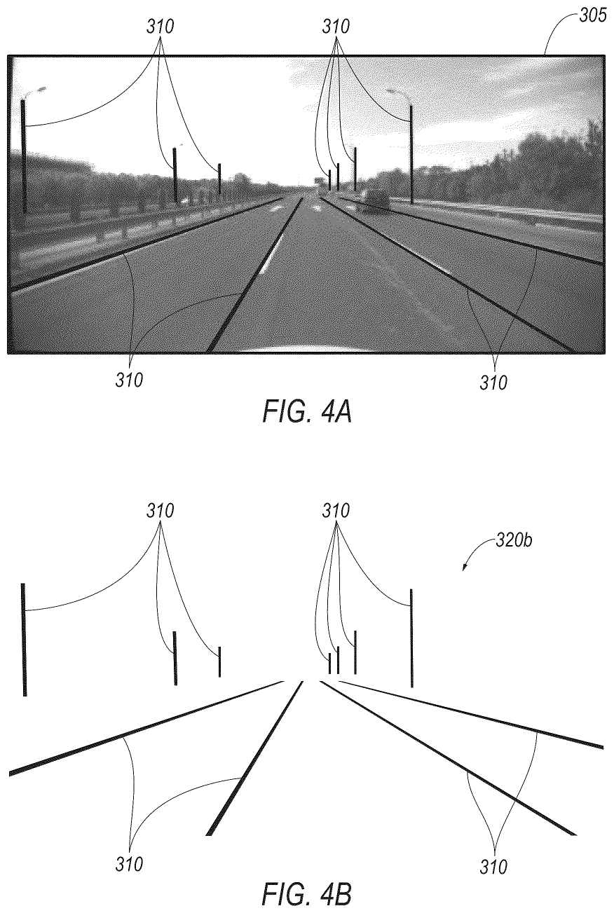

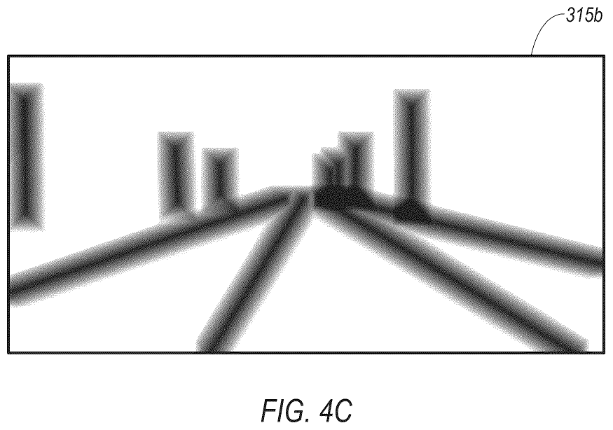

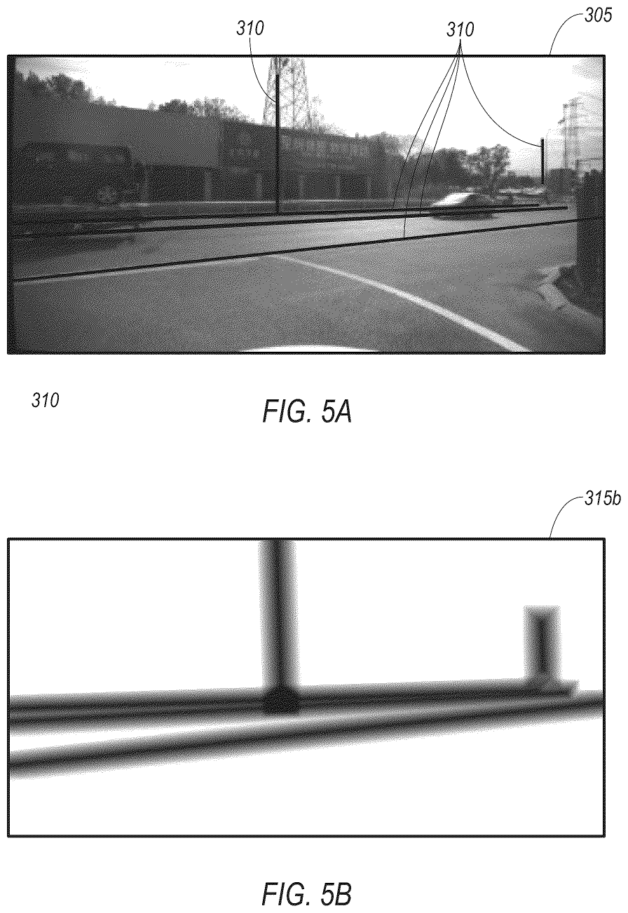

The lane-localization block 255 and the full-localization block 260 employ similar processes, for which an overview is given here and a fuller description is below. In both the lane-localization block 255 and the full-localization block 260, the computer 105 generates a binary image 320 depicting the static environmental features 310, generates a distance transform image 315 from the binary image 320, projects the map data 245 indicating the static environmental features 310 onto the distance transform image 315, and determines a pose 205, 210 of the vehicle 100 that minimizes the value of a cost function. The value of the cost function is based on the map data 245 indicating the static environmental features 310 and the distance transform image 315. The minimization of the cost function starts with the pose 205, 210 at an initial pose. The differences between the lane-localization block 255 and the full-localization block 260 are the initial pose and the perspective. The lane-localization block 255 uses the GNSS pose 215 or the odometry pose 225 as the initial pose, and the full-localization block 260 uses the first pose 205 outputted by the lane-localization block 255 as the initial pose. In the lane-localization block 255, the binary image 320 and the distance transform image 315 are from an overhead perspective, also called a bird's-eye view, and will be referred to as the overhead binary image 320a and the overhead distance transform image 315a, respectively. FIG. 3B shows an overhead binary image 320, and FIG. 3C shows an overhead distance transform image 315a. In the full-localization block 260, the binary image 320 and the distance transform image 315 are from the perspective of the camera 110 and will be referred to as the image-plane binary image 320b and the image-plane distance transform image 315b, respectively; i.e., the image-plane binary image 320b and the image-plane distance transform image 315b have the same image plane as the camera image 305. FIG. 4B shows an image-plane binary image 320b, and FIGS. 4C and 5B show image-plane distance transform images 315b. The use of different perspectives in the lane-localization block 255 and the full-localization block 260 results in high accuracy in three-dimensional space by covering different dimensions in three-dimensional space.

With reference to FIGS. 3A, 4A, and 5A, the computer 105 may be programmed to receive the camera image 305 from one of the cameras 110 via the communications network 115. The camera image 305 is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in the camera image 305, i.e., position in the field of view of the respective camera 110 at the time that the camera image 305 was recorded, can be specified in pixel dimensions or coordinates, e.g., an ordered pair of pixel distances, such as a number of pixels from a top edge and a number of pixels from a left edge of the camera image 305.

The computer 105 is programmed to detect the static environmental features 310 in the camera image 305, for the lane-detection block 235 and the vertical-detection block 240 in FIG. 2. The computer 105 may use any conventional object-recognition technique suitable for identifying the types of static environmental features 310 that are of interest, e.g., lane lines, power-line poles, etc. For example, the computer 105 may execute a machine-learning model such as a deep neural network, e.g., PersFormer for detecting lane lines or YoloV5 for detecting linearly vertical features. The machine-learning model may be trained on camera images from the same perspectives as the cameras 110 on the vehicle 100, annotated with identifications of the static environmental features 310 to serve as ground truth.

The computer 105 may be programmed to determine a geometrical description of at least some of the static environmental features 310, e.g., of the lane lines. The geometrical description specifies the shape of the static environmental feature 310 in two-dimensional or three-dimensional space, e.g., a series of coordinate points in space or a formula for a spline curve. For example, the computer 105 may execute a machine-learning model, e.g., the same machine-learning model as used for detecting the static environmental features 310, e.g., PersFormer.

With reference to FIG. 3B, for the lane-localization block 255, the computer 105 may be programmed to project the static environmental features 310 detected in the camera image 305, e.g., the lane lines, to the overhead perspective. For example, the computer 105 may use inverse perspective mapping, as is known. For another example, the computer 105 may use the horizontal coordinates from the geometrical description of the static environmental features 310, e.g., the coordinates (x, y) from the position (x, y, z).

With reference to FIGS. 3B and 4B, for both the lane-localization block 255 and the full-localization block 260, the computer 105 is programmed to generate the binary image 320 depicting the static environmental features 310. The binary image 320 is a two-dimensional matrix of pixels. Each pixel is a binary variable, i.e., takes one of two values, e.g., 0 or 1. Position in the binary image 320 can be specified in pixel dimensions or coordinates, e.g., an ordered pair of pixel distances, such as a number of pixels from a top edge and a number of pixels from a left edge of the binary image 320. The image-plane binary image 320b may have the same pixel dimensions as the camera image 305. The binary image 320 may depict only the static environmental features 310. For example, the pixels occupied by the static environmental features 310 may have a value of 1 (depicted as black in FIGS. 3B and 4B), and the remaining pixels may have a value of 0 (depicted as white in FIGS. 3B and 4B).

With reference to FIGS. 3C-E, 4C, and 5B, the distance transform image 315 is a two-dimensional matrix of pixels. Each pixel has a pixel value, e.g., a scalar pixel value. Position in the distance transform image 315 can be specified in pixel dimensions or coordinates, e.g., an ordered pair of pixel distances, such as a number of pixels from a top edge and a number of pixels from a left edge of the distance transform image 315. The distance transform image 315 may have the same perspective as the respective binary image 320. The distance transform image 315 may have the same pixel dimensions as the respective binary image 320; i.e., the overhead distance transform image 315a may have the same pixel dimensions as the overhead binary image 320a, and the image-plane overhead distance transform image 315a may have the same pixel dimensions as the image-plane binary image 320b. Each pixel value indicates a pixel distance of that pixel from the static environmental features 310 in the distance transform image 315. For example, each pixel may have a pixel value equal to a pixel distance from that pixel to the nearest pixel that is part of the static environmental features 310. FIGS. 3C, 4C, and 5B represent the pixels coinciding with the static environmental features 310 (i.e., with pixel distance of zero) as black, and increasing pixel distances as progressively lighter. FIG. 3D shows a three-dimensional plot of the pixel values from FIG. 3C, with the horizontal axes corresponding to the pixel coordinates and the vertical axis corresponding to the pixel values. FIG. 3E is a cross-section of the plot of FIG. 3D. The pixel distance may be a Euclidean distance. For example, if (pₓ, p_{y}) is the coordinate of a pixel and (pᵢ, pⱼ) is the coordinate of the nearest pixel that is part of the static environmental features 310, the pixel value D at (pₓ, p_{y}) may be given by the following expression:

$$D ( {p}_{x} , {p}_{y} ) = \sqrt{{( {p}_{x} - {p}_{i} )}^{2} + {( {p}_{y} - {p}_{j} )}^{2}}$$

The computer 105 is programmed to generate the distance transform image 315 of the static environmental features 310 based on the respective binary image 320. The computer 105 may determine the pixel values D for each pixel in the distance transform image 315 as the pixel distance to the nearest pixel that the binary image 320 indicates is occupied, e.g., that has a value of 1.

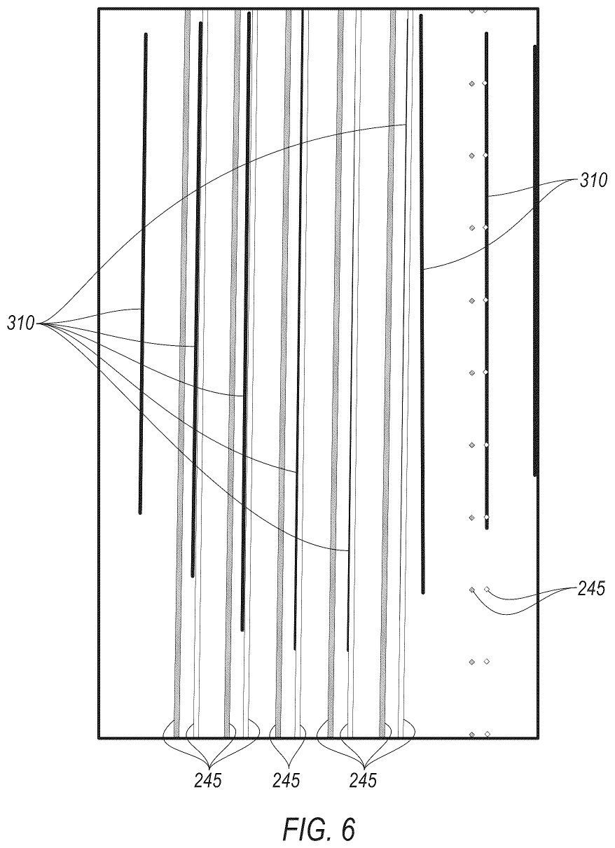

With reference to FIG. 6, the computer 105 is programmed to determine a pose 205, 210 of the vehicle 100 based on a comparison of the map data 245 indicating the static environmental features 310 with the distance transform image 315. The computer 105 may determine the pose 205, 210 that minimizes the value of a cost function. The computer 105 may start with an initial pose and perform an optimization algorithm that iteratively refines the pose 205, 210. At each iteration, the computer 105 projects the map data 245 indicating the static environmental features 310 onto the distance transform image 315 based on the current pose 205, 210, calculates the value of the cost function, and adjusts the current pose 205, 210 to use in the next iteration. The computer 105 may perform the optimization algorithm until a convergence condition is satisfied. FIG. 6 represents the static environmental features 310 as detected in the camera image 305 with black lines, the map data 245 projected with the initial pose with gray lines, and the map data 245 projected with the pose 205, 210 after convergence with white lines.

The computer 105 may be programmed to project the map data 245 indicating the static environmental features 310 onto the distance transform image 315 based on the current value of the pose 205, 210. For example, the map data 245 may be represented as a set of three-dimensional map points, and the pose 205, 210 may be represented as a geometric transformation matrix. For each map point, the computer 105 may calculate a matrix product of the inverse of the pose 205, 210 and the map point, resulting in a point in three-dimensional space, and apply a projection model transforming the point to pixel coordinates in the distance transform image 315, e.g., as in the following expression:

π(W_{Tc}⁻¹ᵢX_{W})

in which π is the projection model, W_{Tc} is the pose 205, 210, and ᵢX_{W} is the ith map point. The projection model is chosen to convert points in three-dimensional space to the corresponding pixel coordinates in the same perspective as the distance transform image 315, either an overhead perspective or the perspective of the camera 110.

The computer 105 may be programmed to calculate the value of the cost function based on the map data 245 indicating the static environmental features 310 and the distance transform image 315, e.g., the pixel values of the pixels of the distance transform image 315 onto which the map data 245 was projected. For example, the cost function may be a summation of the pixel values for each pixel onto which one of the map points was projected, e.g., the squares of the pixel values, as in the following expression:

$${\sum }_{i = 0}^{N - 1} {‖ D ( π ( {{W}_{Tc}^{- 1}}_{i} {X}_{W} ) ) ‖}^{2}$$

in which N is the number of map points and D( ) is the pixel value for the pixel coordinates provided as the argument.

The computer 105 may be programmed to determine the pose 205, 210 of the vehicle 100 that minimizes the value of the cost function, e.g., as in the following expression:

$${W}_{\hat{T} c} = {arg min}_{{W}_{Tc}} {\sum }_{i = 0}^{N - 1} {‖ D ( π ( {{W}_{Tc}^{- 1}}_{i} {X}_{W} ) ) ‖}^{2}$$

The computer 105 may determine the pose 205, 210 that minimizes the value of the cost function by executing an optimization algorithm. The computer 105 may use any suitable optimization algorithm, e.g., iterative nonlinear least squares optimization.

With respect to determining the first pose 205, the computer 105 may detect the static environmental features 310 that are generally horizontal, such as lane lines, in the camera image 305; project those static environmental features 310 to the overhead perspective; generate the overhead binary image 320a from the projected static environmental features 310; generate the overhead distance transform image 315a from the overhead binary image 320a; initialize the first pose 205 at the GNSS pose 215, i.e., use the GNSS pose 215 as the initial pose; and determine the first pose 205 that minimizes the cost function, with the cost function including a projection model for the overhead perspective.

With respect to determining the second pose 210, the computer 105 may detect the static environmental features 310 in the camera image 305; generate the image-plane binary image 320b from the detected static environmental features 310; generate the image-plane distance transform image 315b from the image-plane binary image 320b; initialize the second pose 210 at the first pose 205, i.e., use the first pose 205 as the initial pose; and determine the second pose 210 that minimizes the cost function, with the cost function including a projection model for the image-plane perspective. The computer 105 may detect the static environmental features 310 by detecting the linearly vertical features and using the generally horizontal static environmental features 310 already detected for determining the first pose 205. The computer 105 does not need to project the detected static environmental features 310 to the perspective of the camera 110 because the camera image 305 is already in the perspective of the camera 110.

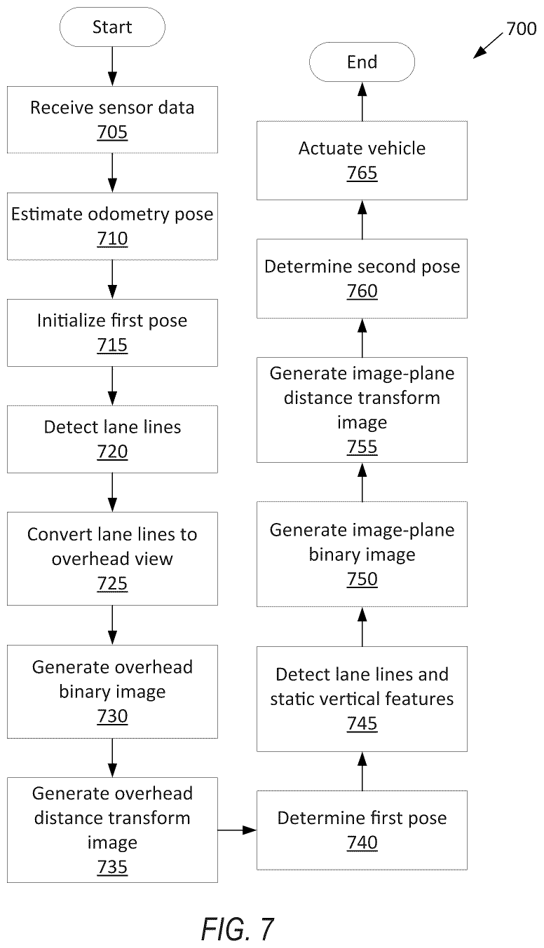

FIG. 7 is a flowchart illustrating an example process 700 for determining the pose 205, 210 of the vehicle 100. The memory of the computer 105 stores executable instructions for performing the steps of the process 700 and/or programming can be implemented in structures such as mentioned above. As a general overview of the process 700, the computer 105 receives the camera image 305 from the camera 110, the GNSS pose 215 from the GNSS receiver 120, and sensor data from the other sensors 125; estimates the odometry pose 225; initializes the first pose 205; detects the generally horizontal features such as lane lines; projects the detected static environmental features 310 to the overhead perspective; generates the overhead binary image 320a; generates the overhead distance transform image 315a; determines the first pose 205; detects the remaining static environmental features 310; generates the image-plane binary image 320b; generates the image-plane distance transform image 315b; determines the second pose 210; and actuates a component of the vehicle 100 based on the second pose 210.

The process 700 begins in a block 705, in which the computer 105 receives the camera image 305 from the camera 110, the GNSS pose 215 from the GNSS receiver 120, and sensor data from the other sensors 125, as described above.

Next, in a block 710, the computer 105 determines the odometry pose 225 based on the sensor data from the other sensors 125, as described above.

Next, in a block 715, the computer 105 initializes the first pose 205 as the GNSS pose 215 from the block 705 or the odometry pose 225 from the block 710, as described above.

Next, in a block 720, the computer 105 detects generally horizontal static environmental features 310 such as the lane lines in the camera image 305 from the block 705, as described above.

Next, in a block 725, the computer 105 projects the static environmental features 310 detected in the block 720 to the overhead perspective, as described above.

Next, in a block 730, the computer 105 generates the overhead binary image 320a based on the projected static environmental features 310 from the block 725, as described above.

Next, in a block 735, the computer 105 generates the overhead distance transform image 315a based on the overhead binary image 320a from the block 730, as described above.

Next, in a block 740, the computer 105 determines the first pose 205 based on a comparison of the map data 245 indicating the static environmental features 310 with the overhead distance transform image 315a from the block 735. The computer 105 may determine the first pose 205 that minimizes the value of the cost function based on the overhead distance transform image 315a from the block 735, starting with the first pose 205 set as the initial pose from the block 715, as described above.

Next, in a block 745, the computer 105 detects the linearly vertical features in the camera image 305 from the block 705, as described above.

Next, in a block 750, the computer 105 generates the image-plane binary image 320b based on the static environmental features 310 from the blocks 725 and 745, as described above.

Next, in a block 755, the computer 105 generates the image-plane distance transform image 315b based on the image-plane binary image 320b from the block 750, as described above.

Next, in a block 760, the computer 105 determines the second pose 210 based on a comparison of the map data 245 indicating the static environmental features 310 with the image-plane distance transform image 315b from the block 755. The computer 105 may determine the second pose 210 that minimizes the value of the cost function based on the image-plane distance transform image 315b from the block 755, starting with the second pose 210 set as the first pose 205 from the block 740, as described above.

Next, in a block 765, the computer 105 actuates a component of the vehicle 100 based on the pose 205, 210 of the vehicle 100. The component may include, e.g., the propulsion system 130, the brake system 135, the steering system 140, and/or the user interface 145. The computer 105 may actuate the component based on the second pose 210, which means that actuating the component is based indirectly on the first pose 205 because the first pose 205 is an input for determining the second pose 210. For example, the computer 105 may actuate the component in executing an advanced driver assistance systems (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. For example, the computer 105 may actuate the steering system 140 based on the distances to the lane lines as part of a lane-centering feature, e.g., steering to prevent the vehicle 100 from traveling too close to the lane lines. The computer 105 may identify the lane lines using the detection from the block 720 and/or the map data 245. The computer 105 may determine the position of the vehicle 100 relative to the lane lines based on the second pose 210 of the vehicle 100. The computer 105 may, if the position of the vehicle 100 is within a distance threshold of one of the lane lines, instruct the steering system 140 to actuate to steer the vehicle 100 toward the center of the lane. For another example, the computer 105 may operate the vehicle 100 autonomously, i.e., actuating the propulsion system 130, the brake system 135, and the steering system 140 based on the second pose 210 of the vehicle 100, e.g., to navigate the vehicle 100 through an area.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
detect static environmental features in a camera image from a camera of a vehicle;
generate a distance transform image of the static environmental features as detected in the camera image, in which pixel values of respective pixels in the distance transform image indicate respective pixel distances of the respective pixels from the static environmental features in the distance transform image; and
determine a pose of the vehicle based on a comparison of map data indicating the static environmental features with the distance transform image.

2. The computer of claim 1, wherein the instructions further include instructions to:
calculate a value of a cost function based on the map data indicating the static environmental features and the distance transform image; and
determine the pose of the vehicle that minimizes the value of the cost function.

3. The computer of claim 2, wherein the instructions further include instructions to:
project the map data indicating the static environmental features onto the distance transform image; and
calculate the value of the cost function based on the pixel values of the pixels onto which the map data was projected.

4. The computer of claim 2, wherein the pose is a first pose, and the instructions further include instructions to:
determine a global navigation satellite system (GNSS) pose based on GNSS data; and
initialize the first pose at the GNSS pose for minimizing the value of the cost function.

5. The computer of claim 1, wherein the static environmental features include lane lines.

6. The computer of claim 1, wherein the distance transform image is an overhead distance transform image from an overhead perspective.

7. The computer of claim 6, wherein the pose is a first pose, and the instructions further include instructions to:
generate an image-plane distance transform image from a perspective of the camera; and
determine a second pose based on the first pose and based on a comparison of the map data indicating the static environmental features with the image-plane distance transform image.

8. The computer of claim 7, wherein the instructions further include instructions to:
calculate a value of a cost function based on the map data indicating the static environmental features and the image-plane distance transform image; and
determine the second pose of the vehicle that minimizes the value of the cost function.

9. The computer of claim 8, wherein the instructions further include instructions to initialize the second pose at the first pose for minimizing the value of the cost function.

10. The computer of claim 7, wherein
the first pose includes only two horizontal spatial dimensions and a heading; and
the second pose includes three spatial dimensions and three angular dimensions.

11. The computer of claim 1, wherein the distance transform image is an image-plane distance transform image from a perspective of the camera.

12. The computer of claim 11, wherein the static environmental features include linearly vertical features.

13. The computer of claim 1, wherein the instructions further include instructions to:
generate a binary image depicting the static environmental features; and
generate the distance transform image based on the binary image from a same perspective as the binary image.

14. The computer of claim 13, wherein the binary image depicts only the static environmental features.

15. The computer of claim 1, wherein the pose includes two horizontal spatial dimensions and a heading.

16. The computer of claim 1, wherein the instructions further include instructions to actuate a component of the vehicle based on the pose of the vehicle.

17. A method comprising:
detecting static environmental features in a camera image from a camera of a vehicle;
generating a distance transform image of the static environmental features as detected in the camera image, in which pixel values of respective pixels in the distance transform image indicate respective pixel distances of the respective pixels from the static environmental features in the distance transform image; and
determining a pose of the vehicle based on a comparison of map data indicating the static environmental features with the distance transform image.

18. The method of claim 17, further comprising:
calculating a value of a cost function based on the map data indicating the static environmental features and the distance transform image; and
determining the pose of the vehicle that minimizes the value of the cost function.

19. The method of claim 18, further comprising:
projecting the map data indicating the static environmental features onto the distance transform image; and
calculating the value of the cost function based on the pixel values of the pixels onto which the map data was projected.

20. The method of claim 17, further comprising:
generating a binary image depicting the static environmental features; and
generating the distance transform image based on the binary image from a same perspective as the binary image.
